(19) United States
(12) Patent Application Publication
(10) Pub. No.: US 2005/0009499 A1
(43) Pub. Date: Jan. 13, 2005

(54) Systems and methods for billing a mobile wireless subscriber for fixed location service

(76) Inventor: Karl Koster, Atlanta, GA (US)

Correspondence Address: Karl H. Koster, Apartment 1, 347 8th Street, Atlanta, GA, 30309, US

(21) Appl. No.: 10/615,080

(22) Filed: Jul. 8, 2003

(51) Int. Cl. H04M 11/00

(52) U.S. Cl. 455/406; 455/422.1; 455/404.1

(57) ABSTRACT

An method for billing a wireless subscriber for fixed location service is disclosed where the rating of a call is determined in part by the location of the subscriber as indicated using call detail record information recorded in the switch and information in a rating profile, typically stored in a billing system. The rating profile maintains a defined billing rate that is applied for calls associated with the subscriber occurring in the defined serving location as typically identified by an antenna and antenna sector.

### FIELD OF THE INVENTION

This invention relates to the billing of subscribers of wireless services. Specifically, wireless subscribers are billed for a fixed location service based on a rating profile comprising antenna information, sector information, and a billing rate as applied to call detail records generated in association with wireless communications.

### BACKGROUND AND SUMMARY OF THE INVENTION

Cellular mobile phones have proved very popular with users since their introduction in the mid 1980's. Since that time, handsets have become smaller, lighter and cheaper. Many wireless phones, including the phones incorporating various technologies known as cellular, digital cellular, PCS, GSM, etc., are small enough to fit inside a shirt pocket and cost a few hundred dollars or less. Users have found the mobility of wireless telecommunications to be extremely beneficial and convenient.

The price of wireless service has continuously dropped since the introduction of wireless services as well. This is due, in part, to economies of scale that has reduced the cost of providing service. More powerful processors and more efficient use of the radio spectrum facilitated by digital technology has also reduced the cost of service. Further, intense competition for wireless subscribers has motivated wireless carriers to offer various pricing plans and discounts.

Historically, wireless carriers obtained governmental operating licenses for operating selected frequencies for a defined geographical areas. These areas were often based on demographic metrics, such as metropolitan areas. Wireless telecommunication subscribers often view these areas where they normally receive service as their “home service area.” When a subscriber operates their mobile phone outside their ‘home service area’ into another area, service is often provided by another wireless service provider. This ‘foreign’ wireless service provider is commonly referred to as a roaming service provider. The roaming service provider not only has a radio license for the roaming area, but also has a billing arrangement with the home service provider. This billing arrangement is called a ‘roaming agreement.’ Today, wireless subscribers are familiar with ‘roaming’ outside of their service area and many wireless service providers have such agreements with each other. Roaming agreements allow subscribers to gain the full benefit of mobility by allowing their mobile phones to be used outside their home service area, or outside other areas served by the wireless service provider. However, ‘roaming service’ may result in increased usage rate to a wireless subscriber when they use their mobile phone while roaming outside their home service area.

Part of the increased cost reflects the additional network technology required by both the home service provider and the roaming partner to provide roaming. Additional network and billing systems are required to provide this service, and the additional cost must be recovered by the wireless provider. This, in turn, usually results in increased charges to the subscriber.

Similarly, even within a home wireless service area, the home service provider must provider various facilities, such as cell sites, in which the cost is spread over the subscriber base. Again, it is desirable from the wireless service provider's perspective to ensure that network resources are fully used at all times. From a service provider's perspective, the more predictable the number of users, the better the network facilities can be engineered to provide service, and allowing the most efficient use of resources and minimizing additional charges. Therefore, a wireless provider that can better predict a network usage can more efficiently plan and engineer the network resources to serve their subscriber base. Engineering these resources includes providing capacity when and where required to ensure the resources are available in all locations for the loads at the required time. For example, the demand for cellular service along the highways correlates with peak commute times, such as rush hour. Thus, there is frequently a high concentration of cellular towers along the path of highways to provide mobile phone service to commuters. However, during other hours, there may be excess capacity that is underutilized. Again, the wireless service provider would desire to have such resources used at full capacity at all times.

One way service providers attempt to balance the load is to motivate or incent users to use the service during certain time periods. For example, carriers frequently offer discounts for usage in the evenings by providing ‘off-peak’ billing rates. This allows a carrier to maximize utilization of resources that may otherwise be underutilized. In other words, service providers often use various billing plans to encourage usage of their network resources during certain times. This allows better utilization of resources, allowing a greater return on investment, and allows greater efficiency and lower costs per subscriber.

Although providing different billing rates based on time of day is effective for shifting traffic from one time period to another, this does not guarantee that all resources (e.g., cellular towers) are fully used during a single time period. To date, there has not been an effective method for shifting traffic to specific portions of the network within a single time period. Thus, while usage may peak for some resources at a given time period (e.g., the cellular towers serving a highway during rush hour are often fully utilizes during rush hour), other resources in the network may not be fully utilized. Thus, a method for incenting usage for specific locations is needed.

A separate aspect impacting wireless telephone service, as well as wireline telephone service, is a governmental regulatory mandate called number portability. One version of number portability is called Local Number Portability and is required by the 1996 Telecommunications Act. This refers to the statutory requirement that local telephone providers allow a subscriber to change service providers without having to change their telephone number. The process of changing the carrier associated with a telephone number is called ‘porting’ the telephone number. For example, a BellSouth® telephone subscriber could change service providers and have their residential telephone number served by MCI® or AT&T®. Local Number Portability was determined to be advantageous for subscribers to gain the benefit of competition among various local telephony providers. The details of how this accomplished is well known to those familiar with local number portability.

This capability is required now for wireless carriers as well. Thus, a Verizon Wireless® subscriber can change their service provider to AT&T Wireless®, providing of course, both carriers provide service to the subscriber in the same area. Wireless Number Portability was deemed advantageous for wireless subscribers to gain the benefit of competition among various wireless service providers.

So far, the discussion of ‘porting’ a telephone number is within the context of changing from one wireline provider to another wireline provider, or changing from one wireless provider to another wireless provider. The capability of porting a number from wireline carrier to a wireless carrier has been identified as having potential benefit for wireless carriers and subscribers. This would provide a subscriber the flexibility of converting to wireless service without changing their number or having to maintain their wireline service in order to retain their published wireline telephone number. This would allow a subscriber to take advantage of more intelligent handsets providing features not typically found on wireline phones (e.g., voice dialing, integrated color displays, etc.). Further, this would provide additional competition for wireline subscribers and potentially provider greater flexibility in service plans. At a minimum, users would enjoy the benefit of a ‘cordless phone-like’ service.

Some wireline subscribers may not be motivated to port their telephone number to a wireless service provider, since the cost may be higher. For example, wireline local service is typically offered on a flat rate basis. However, wireless service is typically offered on a per-minute basis. The economic advantage or disadvantage depends on how the wireless rate plan is established and what usage the subscriber incurs. The rate plan is the schedule for determining the bill for the services. Frequently, various parameters are applied to the calls to define the amount due. In a flat-rate plan, there are no per-minute or usage based rates. In a usage based plan, there is a defined rate for certain using a certain amount—typically measured in minutes/month. There are combination pricing plans that allow a flat rate for calls up to a defined limit that then incorporate usage rates thereafter (e.g., $29 for 300 minutes, with additional minutes at $0.45/minute).

Obviously, a wireless carrier requires different network infrastructure compared to a wireline service provider to offer the convenience of mobility to a wireless user. A wireless service provider must have additional processing and equipment to recognize a user's mobile device anywhere in their network. Thus, additional capital costs are associated with this compared to a wireline provider. If the wireless service provider could reduce the infrastructure required to serve a wireless subscriber, then their capital costs would be lower. This would, in turn, allow the wireless provider to offer lower rates for calls.

Some wireline subscribers porting their number to a wireless carrier may only desire limited mobility. If wireline subscribers who port their numbers to a wireless carrier desire to use their mobile phones in a limited area (e.g., inside their residence only), then these subscribers would not require the ‘mobility’ feature of the wireless network. For these type of wireless subscribers, it may be desirable for the wireless provider to offer such wireless subscribers a lower rate since they are not utilizing the mobility capability of the wireless network. The wireless provider would be providing a ‘fixed location’ wireless service using their existing infrastructure. In practice, the ‘fixed location’ is relative, as some limited mobility may be allowed. This allows a wireless service provider to offer a service emulating aspects of a cordless phone, which offers limited mobility in conjunction with wireline service.

The wireless provider may typically either limit service to such subscribers only to a specific location at one billing rate, or allow mobility and charge a different rate for calls associated with mobility. For example, a fixed location wireless user may use their cellular phone in their residence 90% of the time at one billing rate associated with fixed location service. But then during occasions where mobility is required (and thus requiring use of the wireless provider's network infrastructure for providing mobility), a second billing rate can be applied, possibility commensurate with mobility service rates.

In this manner, a wireless provider can attract additional subscribers, provide more flexible billing arrangements, and increase their revenue. Subscribers have additional competition, pricing plans, and service options.

### BRIEF DESCRIPTION OF THE DRAWINGS

In the drawings, an exemplary embodiment exhibiting various features is set forth. Reference will now be made t the accompanying drawing, which are not necessarily to scale, and wherein:

FIG. 1 illustrates the prior art of a basic wireless architecture involving a cellular system.

FIG. 2 illustrates the prior art of cell sectors associated with a wireless antenna.

FIG. 3 illustrates the prior art of a monopole antenna.

FIG. 4 illustrates the prior art of a cell sector service area.

FIG. 5A illustrates one embodiment of rating a call according to the principles of the present invention.

FIG. 5B illustrates one embodiment of a representation of a subscriber bill generated according to the principles of the present invention.

FIG. 6 illustrates one embodiment of a billing system according to the principles of the present invention.

FIG. 7 illustrates overlapping sector areas for a fixed location service.

FIG. 8 illustrates one embodiment of a process flowchart for rating calls according to the principles of the present invention.

FIG. 9 illustrates how emergency call processing can occur in one embodiment according to the principles of the present invention.

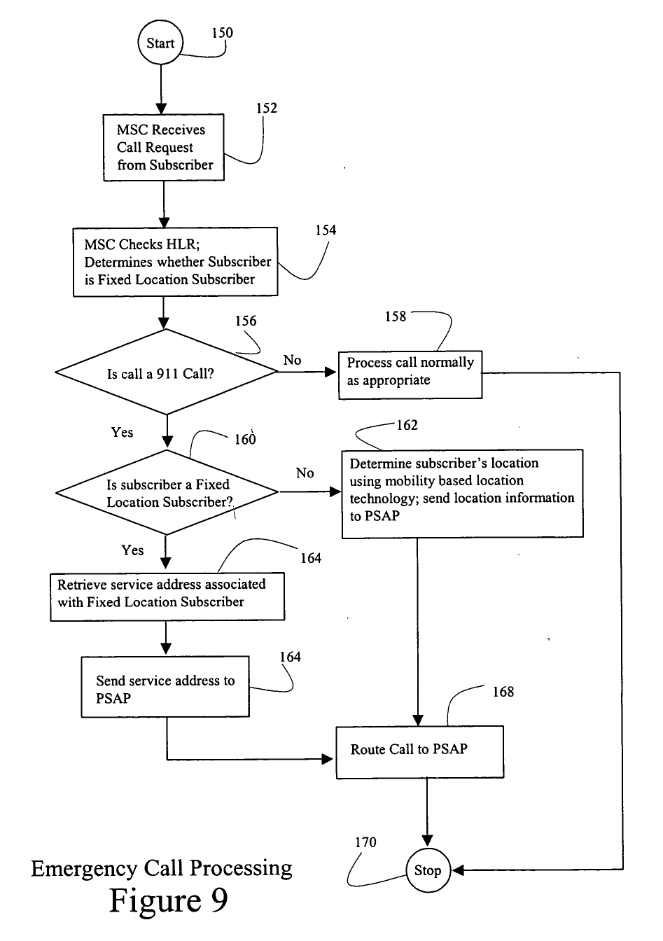

### DETAILED DESCRIPTION OF THE INVENTION

As required, a detailed illustrated embodiment of the invention is disclosed herein. However, the operating structures and processes associated with the illustrated embodiment of the invention may be altered in other embodiments, in a wide variety of forms, some of which may differ significantly from the disclosed embodiment. Consequently, the specific structural and functional details disclosed herein are merely representative; yet in that regard they are deemed to afford the best embodiment for disclosure and to provide a basis for the claims herein, which define the scope of the present invention.

The present inventions will now be described more fully with reference to the accompanying figures, in which some, but not all embodiments are shown. In various figures, similar elements are illustrated multiple times, but are not numbered in every instance so as to make the figures easier to comprehend. Like numbers refer to like elements throughout the figures.

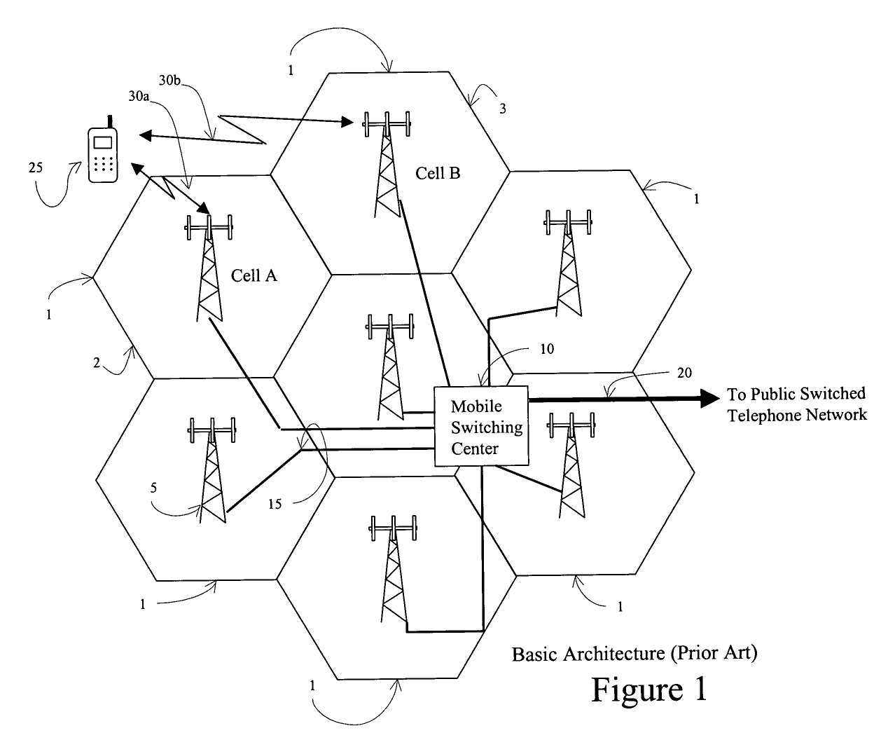

In FIG. 1, the prior art is illustrated and introduces various basic concepts of a wireless system, specifically a cellular system, that facilitates illustration of the invention. It should be noted that a variety of wireless technologies may be used, such as analog cellular, digital cellular, PCS and GSM, all which may operate in various frequency bands. Further, though illustrated in context of a cellular system, the principles apply to other systems, such as Wireless LANs, Wi-Fi, satellite, etc.

In the embodiment of FIG. 1, a plurality of cells 1 are shown. The cells represent an area of radio coverage for an associated cellular antenna 5. The cell shapes are represented as hexagon shape for illustration purposes, since this allows convenient representation of an area of coverage for a given antenna. In reality, radio coverage is irregular, though commonly somewhat circular in shape and dependent on the terrain, geography, buildings, etc. Further, though the cells are shown as adjacent, in reality, the cells overlap. This type of representation is common and well known in the art.

In the center of each cell is an antenna 5, frequently attached to a tower or other type of supporting structure. The distance from the antenna to the edge of the cell represents the effective range of coverage for the antenna, and can be up to several miles. The range depends on the terrain, type of antenna, transmitting power levels, etc.

Each antenna 5 is operatively connected by a communication facility 15 to the Mobile Switching Center 10. These facilities are typically wireline based (e.g., private facilities), but can also be implemented using microwave or other wireless technologies. The Mobile Switching Center (MSC) (‘switch’) is connected via wireline facilities 20 to the Public Switch Telephone Network (PSTN) to allow calls to connect to/from wireline telephone users.

A mobile subscriber is associated with a mobile handset 25 that communicates using radio waves 30 within a defined frequency spectrum with one or more cells 2,3. Typically, a mobile device will communicate with a single cell site antenna, such as cell site 2 using a radio channel 30, but in certain circumstances a second cell site, such as cell site 3, may communicate with the mobile device on a different frequency. This may occur when a mobile subscriber is moving and requires, for example, a call to be handed-off from one cell site to another. This may also occur when a call originates from the mobile handset and two antennas receive the signal. In this case, the switch determines which antenna is receiving a stronger signal and allocates that antenna to handle the call. Similarly, a mobile handset may be paged for an incoming call from multiple antennas and the mobile handset selects the stronger of the antenna signals to accept the call.

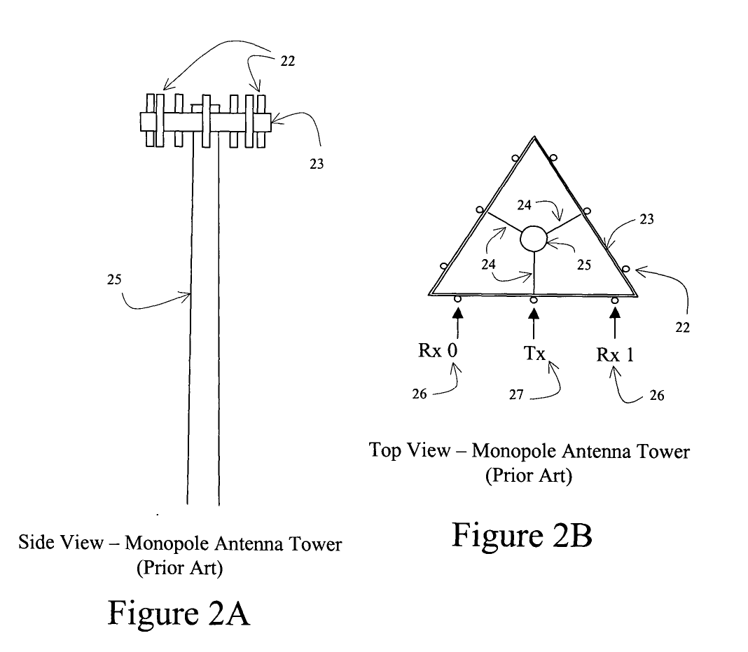

One embodiment of a prior art antenna tower is illustrated in FIGS. 2A and 2B. In FIG. 2A, a side view of a monopole antenna is disclosed. A single metal pole 25 is provided that rises to the desired height, and an antenna mounting bracket 23 is affixed to the pole 25 using struts or arms 24. While early antenna towers initially had a single antenna mounted (as illustrated in FIG. 2A), it is common now for towers to have several antennas mounted in a stacked manner on a monopole antenna tower. Affixed to the antenna bracket 23 are the various antenna elements 22. Other types of antenna towers may be used to support the antenna.

FIG. 2B illustrates the antenna assembly from a top view. The pole 25 is in the center of the assembly and three arms 24 hold the antenna brackets 23 in place. Mounted to any one side bracket 23 are three antenna elements 26, 27. Typically, there are two receiver elements 26 and one transmiter element 27 on a given bracket 23. The two receiver elements provide diversity for signal reception.

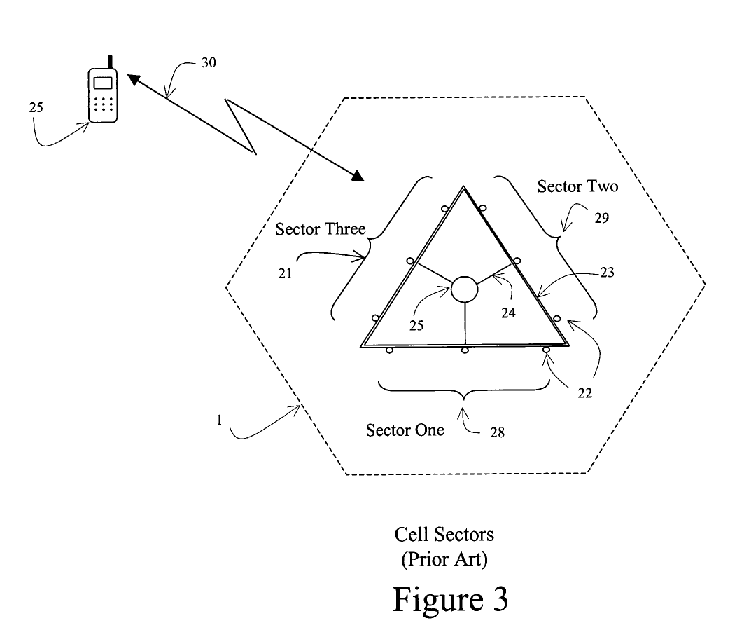

FIG. 3 further illustrates a prior art view of the top view of the antenna, and illustrates the concept of ‘sectors’. In FIG. 3, the antenna assembly 5 has three sectors 21, 28, 29. These form an equilateral triangle, and each side is called a ‘sector.’ Each side is labeled with a sector number, namely sector one 28, sector two 29, and sector three 21. In this illustration, the particular identifier assigned to a particular sector is not critical and it could be identified by a letter, such as “A”, “B”, and “C”, or other types of identifiers.

Each antenna sector typically segregates each cell site coverage into one of three areas. In the illustration of FIG. 3, the mobile handset 25 is in radio communication 30 with sector three 21. The radio signals received by sector two 29 and sector one 28 are weaker since the radio signals are not directed to the mobile handset 25.

When a mobile user moves to a different geographical location, the radio signal from the mobile phone may be received by another sector of the same antenna, or by another sector of a different antenna. In such cases, ‘handoff’ procedures are defined allowing the Mobile Switching Center and mobile handset to coordinate handoff of the call from one sector of an antenna to another sector. The call handoff allows the call to seamlessly continue while the serving antenna sector is switched. This is basically how mobility is provided to users in a cellular system. Thus, in order to coordinate a handoff, the wireless mobility system must keep track of which sector a mobile handset is associated with at any given time.

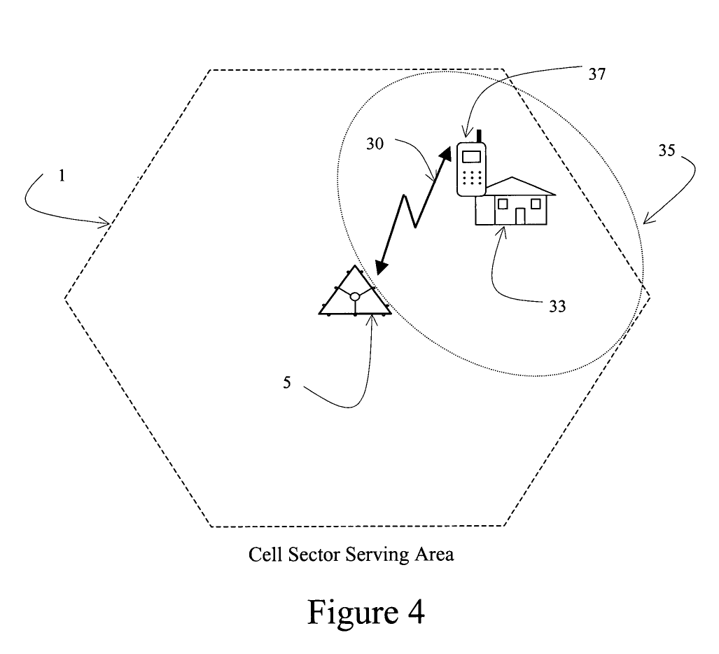

Each sector has a serving area, and this is illustrated in FIG. 4. In FIG. 4, the antenna 5 is illustrated as being in the center of the cell 1. As mentioned previously, the actual coverage area of a cell is not exactly hexagonal, nor circular, but those shapes are convenient representation forms. The serving area 35 of a sector is illustrated as an oval in FIG. 4 to facilitate illustration, but in reality, this is also only an approximation of the exact coverage of the sector varies in practice according to various factors.

FIG. 4 illustrates a residential location, e.g., a house 33, which, by definition is in a fixed location. In FIG. 4, the residence 33 is shown as being within the serving area 35 of the antenna 5. Other residences may be located within the serving area of cell 1, but located in a different sector service area.

In FIG. 4, the subscriber of the fixed wireless service is shown as using the mobile handset 37 in the close proximity of the residence and in radio communication 30 with the antenna 5. It is preferred, though not required, that the mobile handset 37 used for fixed wireless service can be the same mobile handset 25 associated with normal mobility (cellular) services. As evident from FIG. 4, the user of the mobile phone 37 still has some limited mobility associated with the service even if constrained to stay within the location of the antenna sector service area. Typically, the user could use the phone within any portion of their residence or even within their property boundary while staying within the same antenna sector serving area. This provides the fixed location wireless user with limit mobility operation similar to the mobility experienced by a wireline user using a cordless phone. However, there will be cases when the movement within the residence or the property may cause the mobile set to be serviced by another cell sector. This case will be discussed subsequently as a special instance.

Thus, the service of fixed wireless service allows a fixed wireless location subscriber to use their wireless handset in a predefined location as defined by an antenna sector service area. Fixed location wireless users would typically receive a specific billing rate associated with using that service. As previously noted, the user may retain the ability to use their wireless handset in other areas with the mobility capability, but at a different billing rate. Alternatively, the wireless service provider may limit the call to the defined service area and not allow mobility. In this embodiment, the subscriber's status is maintained in the HLRNLR so that when a call originates, the switch knows to prohibit handoff. If the subscriber attempts mobility, then the call would be dropped. For incoming calls, the switch would consult the HLRNVLR to determine a specific antenna to page the mobile handset for the incoming call.

The process of selecting the appropriate billing rate for a fixed location service subscriber is defined by the billing process and involves processing Call Detail Record data. Call Detail Record (CDR) data is data that the Mobile Switching Center collects and records during the lifetime of a particular call. When a call is started, the switch creates a record of information pertinent to that call, including all the information required later to generate a bill for that call. A switch may be handling hundreds of calls simultaneously and each call typically has a Call Detailed Record generated. As bills are generated for each subscriber at a later time, on a different system, the CDR data is typically transmitted from the switch to a billing system. Thus, the CDR file must capture all the pertinent information during the call that might be needed for subsequent bill processing. The generation of generating CDR data may be different from switch vendor to switch vendor, and some vendors may generate more or less information in a CDR record than others. Frequently, additional information is generated that is not required for generating a bill.

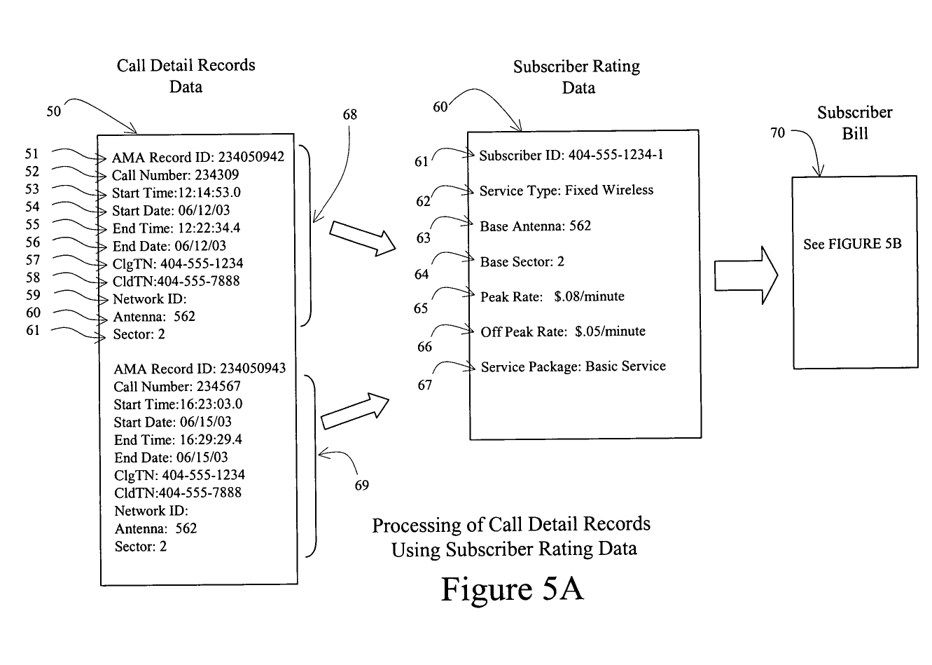

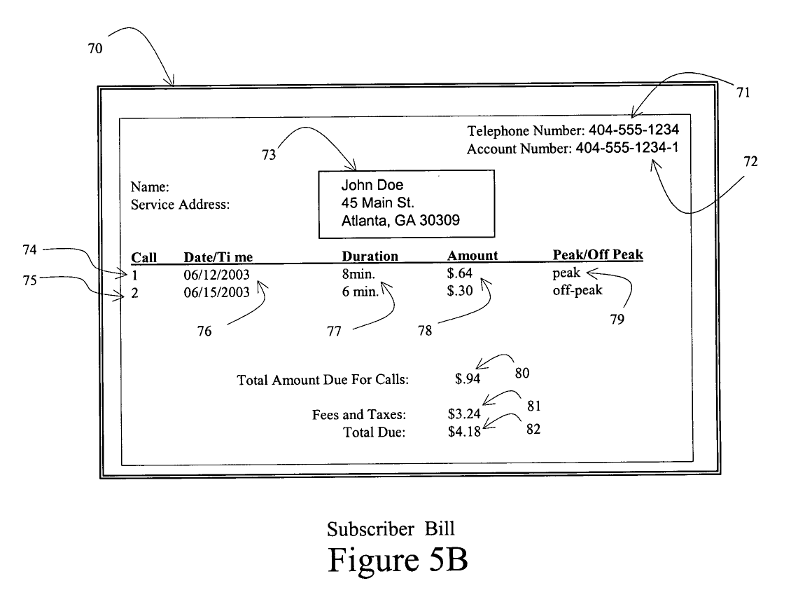

The CDR file 50 illustrated in FIG. 5A illustrates detailed information for two calls 68, 69 associated with the subscriber of fixed location service. In practice, the CDR file typically contains call record information as calls occur in the switch and each file typically contains information for a given time period (e.g., a 24 hour period, such as from 12:01 a.m to midnight of each day). Thus, thousands of such call record groupings such as 68 exist in the file. Thus, a given subscriber's Call Detail Records may be interleaved with Call Detail Records from other subscribers. Consequently, processing of the switch's CDR data file is required to extract and collate all the call records for a particular subscriber. This is typically done by the billing system as will be discussed shortly.

A given Call Detail Record records all the information that the network provider requires to bill the subscriber, as well as perform other non-billing functions. For example, information may be recorded regarding usage of specific network elements, which can be useful in diagnosing problems, network element utilization, or other statistical studies to optimize network operation. Thus, the information illustrated for the call record 68 may be augmented by additional information. Further, many other elements related to a call may be recorded, however, the information disclosed illustrates the principles of the present invention.

The first field of the call detail record is the “AMA Record ID” 51, which stands for Automatic Message Accounting Record Identifier. The acronym “AMA” is rooted in wireline terminology and may have a different corresponding name in wireless environment, such as Message Detailed Recording, or a Call Detail Record. Whatever the name used, record identifier functions to index the call record. This value may be a time stamp, a sequential number incremented for each call record, a combination thereof, or some other format (e.g., concatenating a switch identifier with a date/time stamp). The purpose of the Record Identifier is primarily to uniquely identify the record, and facilitate retrieval, storage, and identification of the record.

The next element illustrated is a Call Number 52 that uniquely identifies the call. Again, this value may be sequential, a time stamp, or some other format. The reason for having a separate record identifier and call number is, in part, that actions may occur in which no call established, but a call record is desired to be recorded. For example, a user may request a service (e.g., activation of call forwarding) that does not necessarily result in a call being established. Also, the generation of call identifiers may be performed independently from the process generating AMA Record Identifiers.

Presuming that a call has occurred and the Call Number 52 has been allocated by the Mobile Switching Center and recorded in the file, the Start Time 53 is also recorded. This indicates the start time of the call. Similarly, the Start Date 54 indicates the day the call originated. The End Time 55 and the End Date 56 similarly indicate the end of the call. It is possible that different formats and structures can be used.

Next, the Network ID 59 indicates the network that the call originated on. This allows a service provider to identify separate networks. The Antenna field 60 contains a number or other means of identification that uniquely identifies the antenna. In mobility applications, there may be a plurality of antennas indicated for the duration of the call, but in this illustration, the wireless subscriber is in a fixed or limited geographic location such that a single antenna number is associated with the call. The identification of a particular antenna can be accomplished in different ways. For example, the number could be unique among all the antennas, or a Mobile Switch Center identifier could be concatenated with the antenna number, or an antenna tower number may be used to uniquely identifies the antenna. The antenna tower number could even be identified by its location coordinates (e.g. longitude and latitude). Those skilled in the art will readily recognize that numerous variations exist as to how to identify the antenna that handled the call.

Finally, a Sector number 61 is also recorded. Again, since the mobile user is fixed in location, the sector number is typically a single numerical value. Typically, a value from 1 to 3 is used, reflecting the three sectors on an antenna, although other identifiers could be used. The sector number on the CDR record is presumed to be the sector associated with the antenna identified by the antenna field 60. Obvious variations are possible, such as specifying the sector number by appending a number to the antenna identifier, thus eliminating the need for a separate sector identifier. Various other equivalent forms are possible by concatenating the antenna and sector identifiers into a single identifier.

In general, all the values illustrated with the above parameters can be changed with respect to their structure and length. For example, some embodiments may record the time of a call within a second, tenth of a second, of even a hundredth of a second. Some embodiments may use a 24 hour format, or an a.m./p.m. indicator. Other embodiments may have an integrated start time/start date value, as well as a integrated end time/end date value. Typically, there are additional fields indicated in the Call Detail Record, such as a parameter indicating the nature of a call (local, long distance, emergency service call, incoming, outgoing). Some fields may have different names. For example, the wireless industry frequently refers to a ‘telephone number’ as a “mobile identification number” (MIN). The format, structure and contents of the information in a call detail record typically varies from one switch vendor to another. Thus, those skilled in the art will recognize that significant variations may exist as to the exact details and structure of the call detail record file 50. However, such variations are within the principles of the present invention.

Recall that the switch typically records each Call Detail Record in chronological order for all subscribers served by the switch. Consequently, the Call Detail Record File 50 is typically processed by the billing system to combine the call records for a single mobile subscriber into a single file. This process facilitates generating a bill for the subscriber, although other approaches may be used, which provide other advantages. For example, it is not required that all records from a single subscriber are segregated from the data file in the switch; rather, data file can be processed sequentially and identifying any subscriber records that need to be rated. In FIG. 5A, the Call Detail Record File 50 has been processed to contain only the records for a given subscriber. In this illustration, there are only two call records 68, 69 associated for the subscriber in the billing period. Typically, there will be many more, but this limited number facilitates presentation of the principles of the invention.

The bill 70 is generated by processing each Call Detail Record 68, 69 in conjunction with the Subscriber Rating Data 60. The Subscriber Rating Data 60 contains information used to determine how to rate each call. Each Subscriber Rating Data profile is typically identified by a Subscriber Identifier 61, which in this embodiment is based on the subscriber's telephone number appended with another identifier. For example, the subscriber's telephone number may (404) 555-1234 100 that is appended with another identifier 101 that in this embodiment, is 1. The use of the telephone number by itself may not be sufficient or desirable to identify the particular subscriber, particularly if the subscriber has multiple mobile phones with different numbers on a single account. However, in this embodiment, the subscriber has only a single mobile number and this effectively illustrates the principles of the present invention.

The Subscriber Rating Data 60 also contains a Service Type 62 indicator. This provides a categorization of the type of service provided to the subscriber. There is significant flexibility for a service provider to define various service types and interpret their meaning. In this embodiment, this value indicates the subscriber has “fixed wireless” service. This indicates that the subscriber is not a typical mobile wireless user, but one that is restricted in mobility. Another value that could be defined is “mobility” that would indicate a traditional mobile wireless subscriber. The service type typically indicates a set of rules used to process the call.

Since the service of ‘Fixed Wireless’ service limits the subscriber to using the phone in a limited area (e.g., their residence), the Subscriber Rating Data includes the Base Antenna 63 identifier and a Base Sector identifier 64. These values correspond to a default antenna and sector associated with the subscriber of the fixed location service. It is not required that a sector is indicated along with the antenna, as some types of antennas may be omni-directional and can be viewed as having only a single sector associated with the antenna. Alternatively, an antenna's cell coverage, including all the sectors, may define the fixed location. This simply provides a larger fixed location that the subscriber can obtain the service. This would allow a service provider to provide limited mobility (i.e., handoff between sectors) of a single antenna. It is even possible that the service provider could define two sectors on two different antennas as the ‘fixed location’ serving area. The Subscriber Rating Data may further include rating information based on other metrics than location. For example, a rating profile could include time as a metric. Further, a Peak Rate 66 and an Off Peak Rate 66 can be defined for used in rating a call on the subscriber's wireless phone. In this embodiment, the Peak Rate is $0.08/minute, while the Off Peak Rate is $0.05/minute. Various schemes can be defined as to how the time schedule is applied. Typically, the limitation with time based rating schemes is that the call must start in a given time period to have that rate apply. Additional limitations include that the call must start and end within a given time period for that rate to apply. Further, the duration of the call can be rounded to the nearest minute, group of seconds, second, or other value.

When each Call Detail Record is processed according to the Subscriber Rating Data, a bill can then be generated for the subscriber. The processing in this example involves multiplying the call duration (rounded up to the nearest minute) by the rate to determine the amount due for the call.

One embodiment of a bill is illustrated in FIG. 5B. The bill 70 may have a variety of formats and information provided, and the variation illustrated for this embodiment is but one of numerous possibilities are possible. Thus, those skilled in the art will realized that different formats and presentations are possible without deviating from the principles of the present invention.

In FIG. 5B, the subscriber's mobile telephone number 71 is typically provided on the bill. In this example, it is 404-555-1234. A separate account number 72 may be present, and this may incorporate portions of the subscriber's telephone number. In this example, the account number is the mobile telephone number with a “1” appended. If the user has multiple phones with different telephone numbers, the account number may incorporate portions of the first telephone number obtained by the user. Alternatively, the account number may not be based on the subscriber's telephone number or based only in part on the number.

The subscriber's name and billing address 73 are provided. This information may be included in the subscriber's Rating Profile 60 or may be stored in a separate name/address file that is indexed by account number. This information is typically printed on the bill to facilitate mailing of the bill using specially designed envelopes.

In this embodiment, there are two rows of information 74, 75 corresponding to the two call detail records 68, 69. Again, typically more calls will be listed, but the limited number facilitates presentation while demonstrating the principles of the invention. In the first row, each call is numbered 74, information is provided comprising the time and date of the call 76, the duration of the call 77, and the amount of the call 78. Finally, a peak/off peak billing rate indication 79 is provided.

The first call in the bill 74 correspond to the first call detail record 68. The Date/Time of the call 76 is based on the Start Time 53 and Start Date 54 in the Call Detail Record. It is not required that the same format be used, as the bill will typically present information in a form that is easier to understand. For example, the bill may use a.m. and p.m. indicators while the format recorded in the CDR data file is based on format to facilitate computer processing (e.g. 24 hour based time). The Duration 77 indicates the duration of the call and is determined in part by the difference between the Start Time 53 and End Time 55 of the call. In this embodiment, the difference between 12:22:34.4 and 12:14:53.0 is 7 minutes 41.4 seconds. A wireless provider may round up the duration to the nearest minute and in this embodiment, the bill reflects a duration of 8 minutes. Based on the peak rate of $0.08/minute 65 indicated by the Subscriber Rating Data 60, the amount 78 of call is shown as $0.64, which is determined by multiplying the duration by the rate. Finally, the peak time indication is indicated by applying a separate schedule that defines when calls are rated as peak or off peak. In this illustration, the call occurred at 12:22 p.m. and is within the ‘peak’ call time. This is typically determined prior to calculating the amount due, since the determination of peak/off peak may impact the rate used.

Finally, a subtotal for the call totals 80 is provided, as is a line item for various taxes and fees 81 and the overall total due 82.

Frequently, a bill includes additional information pertaining to subscriber related events, such as activation services (e.g., call forwarding). Some carriers provide a service of providing detailed bills—listing details for each call. For example, the bill could indicate the number dialed for each call and the exact duration to the closest second. Other carriers may provide a summarized bill with less detailed information. Long distance and roaming calls may be segregated out. Rate plan schedules may be provided. However, this embodiment illustrates the principles of the present invention that includes rating of calls at a specified rate for calls that occur in a defined area.

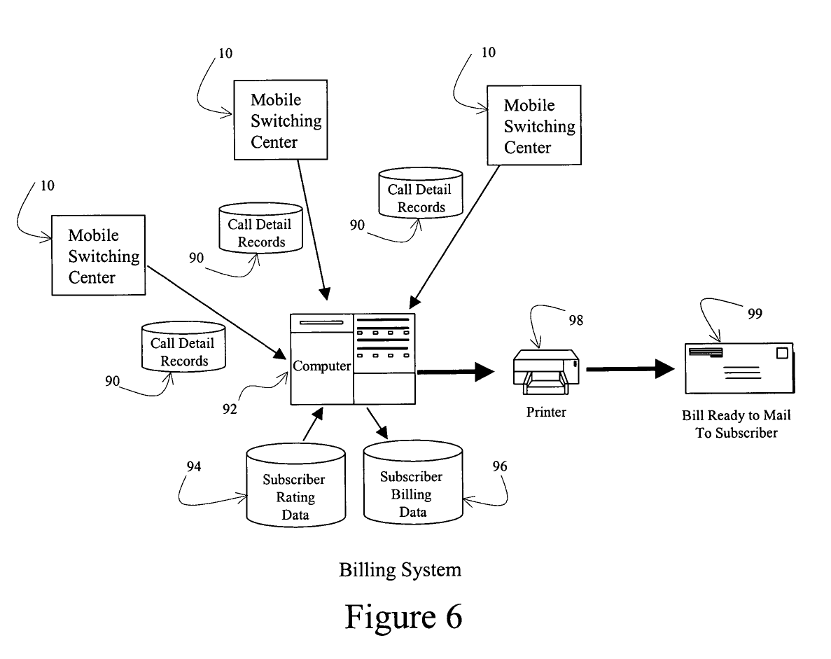

FIG. 6 illustrates the billing system that collects and processes the data required to generate a bill. Typically, a plurality of MSCs 10 periodically send their respective Call Detail Records files 90 to central billing processor 92. Typically, these do so at different times so as to spread out the processing of the billing system over time. The billing processor receives and stores the various Call Detail Records. The billing processor 92 extracts the call detail records for a particular fixed location wireless subscriber, which should be contained within a single MSC's Call Detail Records file. Only if the subscriber is mobile or orginates/receives calls outside of their fixed location serving area will there potentially be call detail records for a subscriber potentially in other MSC CDR data files.

The billing processor 92 retrieves the Subscriber' Rating Data 94 from a database and processes each instance of a call as previously described. This information is then stored in a Subscriber Billing Data file 96. The actual bill may be generated at the appropriate time according to the subscriber's billing cycle. Once the bill is to be generated, the processor retrieves the Subscriber Billing Data 96 and sends the information to a high speed, high volume printer 98. In some embodiments, the data is sent to a third party that provides a service of generating bills and creates the actual mailpieces 99 comprising a bill and envelope with appropriate postage. At this point, the mailpiece 99 is ready to be delivered to the Postal Service for delivery to the subscriber. It is typically the case that the subscriber's billing address is the same as the service address, but this is not a requirement.

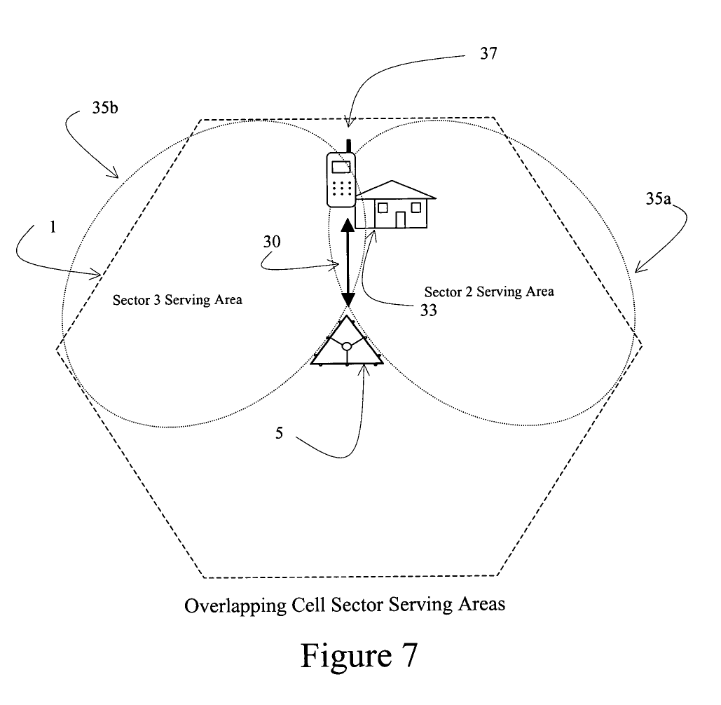

At this point, different aspects of the invention and/or different embodiments are discussed. FIG. 7 illustrates a situation where a fixed mobile handset 37 is used in a subscriber's residence 33 and the residence is located so that two different sectors 35a and 35b both receive the signal from the mobile device. The ‘fixed location’ of the subscriber ‘straddles’ two sector service areas of the same antenna. A similar problem exists when the fixed location straddles two sectors of two different antennas. More accurately, it is when the mobile handset sends/receives a radio signal that is received by different antenna sectors. In this situation, it is possible that calls to/from the mobile handset may occur using either the serving area of sector two 35a or the serving area of sector three 35b.

In this situation, one solution is to augment the Subscriber Rating Data file with a secondary antenna identifier and a secondary antenna sector identifier. These values, as well as the primary antenna and sector identifiers are compared with the antenna number and sector number associated with the call to determine if the call is a fixed location service type call. Thus, a call associated with either one of the two defined antenna sectors would be rated as a fixed location wireless call. This could be extended in the rare situation that the radio signal is received by three or more sectors. However, it is thought that at most two identifiers would be sufficient to handle the vast majority of cases.

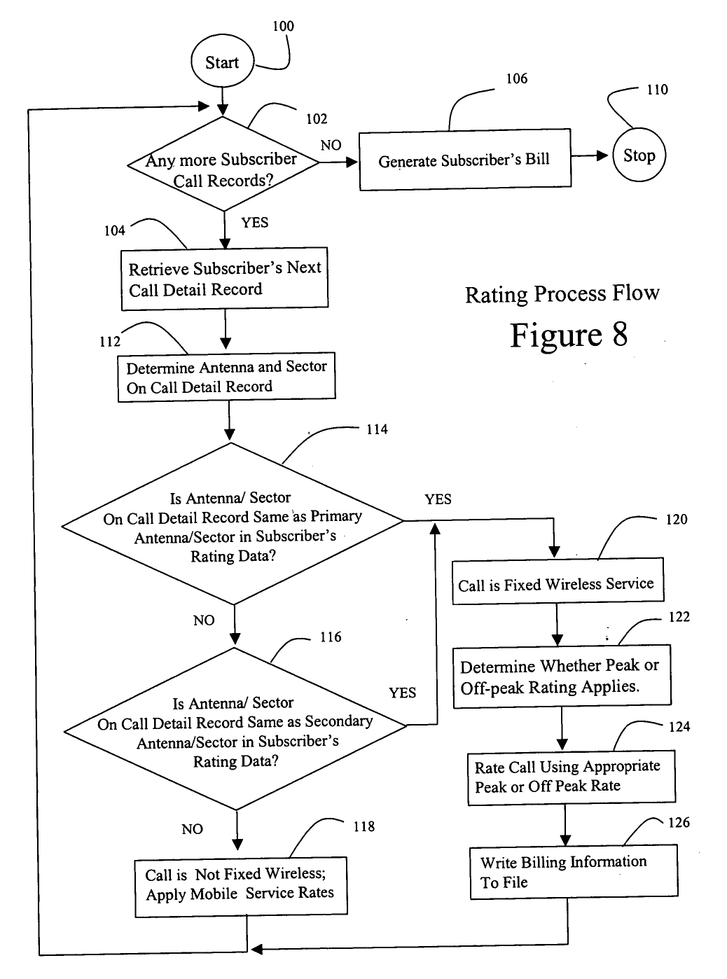

FIG. 8 illustrates one embodiment of the rating process in a flowchart. In this embodiment, the billing system processor starts at step 100 after it has retrieved the subscriber's Call Detail Record data file. It is assumed that another portion of the billing system has already collated the subscriber's records into a file. The billing system typically processes call records serially, and determines whether there are any more records at step 102. If the answer is no, then step 106 indicating that all call records have been rated and the subscriber's bill can be generated for that billing period. If there are more records to be processed, then the next record from the call detail record file is retrieved at step 104. The information in the call detail record is analyzed in step 112, specifically the antenna and sector number that is associated with the call. Next, step 114 examines the antenna and sector indicated in the call detail record to see whether it is the same as the primary antenna and sector indicated in the subscriber rating data file. This process flow presumes that the subscriber rating profile indicates a primary and secondary antenna and sector for the situation where a subscriber may be served by two different antenna towers or two different sectors of the same antenna. If there is a match, then the call is a fixed wireless service type of call as indicated in step 120. If the antenna/sector does not match the values in the subscriber rating profile, the billing system then checks to see whether the antenna/sector in the CDR matches the secondary antenna/sector in the rating profile. If this matches, then this indicates the call is a fixed wireless call, but the call was handled by the secondary antenna/sector. The process continues at step 120.

If the antenna and sector in the Call Detail Record does not match that listed in the Subscriber Rating profile, then the call is billed as a normal mobile wireless call in step 118 according to the schedule defined for such calls. The process then loops back to step 102 to process any more remaining Call Detail Records.

The rating for fixed wireless service occurs starting at step 122 where the system applies any peak/off peak determination by determining the time of the call. It then rates the call, typically based on duration, using the appropriate call rate (e.g., fixed location peak or off-peak rates). The billing system may determine the duration by rounding up duration of the call, using the exact duration, or some other approach. Duration is typically rounded up to the closest minute, although other time increments could be used. Finally, once the call has been rated, the information is written to the subscriber billing data file at step 126. The process then loops back to step 102 where any remaining records are processed. When all records are processed, then the bill is generated in step 106 and the process is completed at step 110. The bill can be printed and then mailed.

Of course, variations are possible in that a fixed number of minutes can be allocated at a flat rate, with the minutes over the fixed number billed at a per-minute rate. For example, the subscriber could have a billing plan were up to 1000 minutes are provided at a fixed rate (e.g., $39.95, with each additional minute at $0.45/minute). Various pricing options can be combined in various ways with the fixed wireless billing algorithm. Thus illustrates the flexibility of applying the principles of the present invention with respect to defining a particular service that has different billing structures. In addition, a wireless service provider could define a combination of traditional mobility and fixed wireless location service plans. Specifically, the subscriber can use their mobile handset in a fixed location service mode (e.g., in their residence) at a fixed location discount rate and use their mobile handset in a mobility service mode at regular mobility rates. Similar variations as existing in mobility pricing plans could also be offered in fixed location pricing plans. For example, a fixed location subscriber could be offered a fixed number of minutes per time month at one rate, with minutes over the fixed number at a second rate. Subscriber could combine unused minutes from a fixed location service and ‘roll over’ the minutes into their mobility service plan. A subscriber could have multiple fixed location service plans. This would allow a user to use their mobile phone at home and work and receive the fixed location plan rate at either location. In addition, as previously noted, the wireless carrier could offer certain times in which fixed location wireless calls are billed at peak or off peak rates.

Regardless of the above noted variations, the basis of billing the subscriber at a differentiated rate based on an antenna or antenna/sector in conjunction with a specified rating level constitutes one aspect of the present invention.

The determination of which antenna and sector to incorporate into the fixed location for the subscriber can be accomplished in several ways. In one embodiment, the subscriber at service enrollment indicates a street address for which they desire the fixed location billing service. A service representative of the wireless carrier uses a computer program that maps the location relative to the closest antenna and sector coverage area. This allows identification of the appropriate antenna and sector, which is then recorded in the subscriber's rating profile. However, this presumes the wireless carrier has previously mapped the coverage of each sector of their antennas.

Another embodiment involves the subscriber initializing their mobile device by dialing a defined activation number at the fixed location that the mobile handset is to be used. At that point, a call is originated from the desired location, and the call to that specific number causes the wireless system to read the antenna number and sector used for that call. It then stores the values in the rating profile. Alternatively, the call detail record for the call to that number can be manually inspected to determine the antenna and sector. Regardless of how the appropriate antenna and sector is obtained, it is then stored in the Subscriber's Rating Data file.

The above invention is applicable to a variety of cellular based systems, including analog cellular, digital cellular, PCS, GSM, CDMA, and other types of technologies and operating at various frequencies. The antennas can be of various types, including directional, omni-directional, and ‘smart’ antennas that vary in operation according to monitored conditions. The antennas are not required to have separate sectors, though that is commonly how cellular systems are deployed. Further, the mobile handsets can be various types of mobile telephones, and can be also data devices such as PDAs, integrated phones/PDA, wireless enable laptops, or other wirelessly communicating device.

Further, the invention is applicable to not only voice calls, but to data or text calls, whether packetized or not. This includes short message service, GPRS, CDPD and various other types of wireless data. The principles of the invention also apply to various wireless LANs, including those referred to as Wi-Fi and based on the various EEE standards of 802.11b, 802.11a, 802.11g, etc., as well as Bluetooth based standards. The identification of subscribers is illustrated as based on telephone numbers, but alias addresses, IP address, MAC addresses, or other schemes could be used to identify a subscriber and associated billing information. Finally, billing is illustrated as generating paper bill that is mailed to a subscriber, but the bill could be communicated electronically. In addition, or alternatively, the billing system could debit an account, such as a credit card or other monetary based financial account and receive payment directly or indirectly from a third party for the amount due. Those skilled in the art will recognize that a wide variety of billing approaches can be used to achieve the principles of the present invention.

The operation of call origination for a fixed wireless call requires additional consideration when an emergency call is originated. An emergency call is a 911 dialed call, and certain procedures are invoked when 911 is dialed. The E-911 (enhanced 911) call system for wireline has a provision of providing location information delivered to the PSAP (Public Safety Answering Point) along with the call. Typically, a street address is used for the location that corresponds to the location of the termination of the wire facility. However, there is no corresponding location for wireless service, that is a the typical mobility based wireless service. There has been various technology developed for determining the location of a wireless mobility caller, but with fixed location wireless service, these technologies are not as accurate as providing the address of the location of the fixed location subscriber. This has the added benefit of providing an address of where the fixed location subscriber is located, which is easier to direct emergency personnel than it is directing emergency personnel to a location coordinate.

In the fixed location service, the HLR/VLR may maintain an indication that the caller is a fixed location subscriber. This allows the switch to know at call establishment that handoffs are not required, and to invoke any special CDR recording procedures, if necessary. Upon receiving the call request, the MSC consults the HLR and determines the subscriber is a fixed location subscriber. Upon analyzing the called party number, which in this case is 911, the switch retrieves a service address and sends the call and the address information to the PSAP.

The procedure for sending location information for a wireless emergency call is illustrated in FIG. 8. Beginning at the starting point 150, the MSC receives a call origination request from the subscriber 152. When the subscriber dials a call, the MSC checks the telephone number of the mobile handset (known as the MIN in some cases). The MSC uses the number of the mobile handset to check the HLR in step 154. (Alternatively, a VLR or other cache memory could be checked). The HLR contains information indicating whether the subscriber as a fixed location wireless subscriber. Next, the MSC determines if the call is an emergency (i.e., 911) call at step 156. If the call is not an emergency call, the MSC process the call origination at step 158 normally. If however, the call is an emergency call, then step 160 occurs. In this step, the MSC determines whether the caller is a fixed location wireless subscriber. If the caller is not, that is, the caller is a traditional mobility subscriber, then at step 162 the MSC determines the callers location using the current location procedures implemented for wireless mobility subscribers. There are a variety of technologies used and those skilled in the art of wireless 911 location technology will readily know the procedures that can be used to send the location information to the Public Safety Answering Point (PSAP), which is the 911 call center handling the calls. The process then continues by routing the call to the PSAP in step 168. If however, the subscriber is a fixed location subscriber, then the process continues at step 164. At this point, the MSC retrieves the address indicated by the user as the fixed location. This address may be stored in the HLR, the MSC, or in an adjunct database, such as in the billing system. The MSC arranges for that information to be sent to the Public Safety Answering Point (PSAP) in step 166. Although not shown, the MSC could augment this information with the location procedures used for traditional mobility subscribers. This would provide two location information data values to the PSAP. Finally, the voice call is routed to the PSAP, as it would for traditional mobility subscribers in step 168 and then the process is completed at step 170. In this manner, more accurate or additional information regarding the location of a fixed location wireless subscriber may be provided to the PSAP.

1. A method of billing a wireless subscriber using a mobile telecommunications device for wireless communication services comprising the steps of:
processing a call associated with an originating address associated with the mobile telecommunications device, said processing performed by a mobile switching center connected to an antenna wherein the antenna is in radio communication with the mobile telecommunications device;
determining a first antenna identifier of the antenna associated with the call;
recording the call start time and the originating address associated with the call in a call detail record data file maintained in the mobile switching center;
transferring the call detail record data file from the mobile switching center to a data processing center;
retrieving a rating profile associated with the originating address associated with the mobile telecommunications device comprising a second antenna identifier and a first billing rate; and
determining an amount to be billed for the call based in part on the comparison of the first antenna identifier with the second antenna identifier and the first billing rate.

2. The method of claim 1 wherein the call is a voice telephone call.

3. The method of claim 1 wherein the call is packetized data communication.

4. The method of claim 1 wherein the originating address is a telephone number.

5. The method of claim 1 wherein the originating address is an Internet Protocol address.

6. The method of claim 1 wherein the step of determining the amount to be billed further comprises using the first billing rate if the first antenna identifier matches the second antenna identifier and a second billing rate if the first antenna identifier does not match the second antenna identifier.

7. The method of claim 1 wherein the step of determining the amount to be billed further comprises using a first billing rate determined in part by comparing a time schedule with the recorded call start time.

8. The method of claim 7 wherein the time schedule contains a peak time period associated with the first billing rate and an off-peak time period associated with a secod billing rate.

9. A method of billing a wireless subscriber using a mobile telecommunications device for telephony services comprising the steps of:
processing a communication associated with an originating address, the originating address associated with the mobile telecommunications device, said processing using a switch connected to an antenna wherein the antenna is in radio communication with the mobile telecommunications device;
determining a first antenna identifier and a first antenna sector identifier associated the communication between the mobile telecommunications device and the switch;
recording the communication start time, originating address and antenna sector identifier in a call detail record data file stored in the switch;
transferring the call detail record data file from the switch to a data processing center;
retrieving a rating profile associated with the originating address comprising a second antenna identifier, antenna sector identifier, and a billing rate; and
determining an amount to be billed for the communication based in part on the comparison of the first antenna identifier with the second antenna identifier, the comparison of the first antenna sector identifier with the second antenna sector identifier, and the billing rate.

10. The method of claim 9 wherein the communication is a voice telephone call.

11. The method of claim 9 wherein the communication is an instance of packetized data communication.

12. The method of claim 9 wherein the packetized data communication uses an 802.11 based wireless communications standard.

13. The method of claim 9 wherein the originating address is a telephone number.

14. The method of claim 9 wherein determining the amount to be billed further comprises using a first billing rate if the first antenna identifier matches the second antenna identifier and the first antenna sector identifier matches the second antenna sector identifier, and a second billing rate if the first antenna identifier does not match the second antenna identifier.

15. The method of claim 9 wherein the billing rate is dependent on a time schedule and determining the amount to be billed further depends on the communication start time recorded in the call detail data file compared to the time schedule.

16. The method of claim 14 wherein the time schedule contains a peak time period and an off-peak time period.

17. A method of billing a wireless subscriber of a wireless telephone call comprising the steps of:
recording call detail information for the wireless telephone call in a file stored in a mobile switching center wherein the call detail information comprises the starting time of the wireless telephone call, ending time of the call, originating telephone number, first antenna identifier and first antenna cell sector identifier associated with the call;
processing the call detail information by determining whether the first antenna identifier and first antenna sector identifier associated with the call is the same as a second antenna identifier and second antenna sector identifier in a rating profile wherein the rating profile is associated with the originating telephone number; and
calculating a monetary amount associated with the call in part by determining the duration of the call and using a first billing rate indicated in the rating profile if the first antenna identifier and first antenna sector identifier associated with the call is the same as a second antenna identifier and second antenna sector identifier in a rating profile, or
by determining the duration of the call and using a second billing rate indicated in the rating profile if the first antenna identifier associated with the call is not the same as the second antenna identifier in the rating profile.

18. A method of billing a wireless subscriber for communication services associated with a call originating from a mobile telecommunications device located in a certain geographical location comprising the steps of:
recording call detail information in a file wherein the call detail information comprises a starting time of the call, a ending time of the call, an originating telephone number of the caller, and a first geographical location indicator associated with the call;
transmitting the call detail information to a billing system;
determining the amount due for the call by using the geographical location indicator of the call, the duration of the call, and a subscriber billing rate wherein the amount due is determined in part by whether the first geographical location indicator of the call matches a second geographical location indicator contained in a rating profile associated with the originating telephone number; and
recording the amount due in a billing file associated with the originating telephone number.

19. The method of claim 18 wherein the location indicator comprises an antenna number.

20. A system for billing a wireless subscriber for a wireless call where the subscriber originates a call within a certain prearranged geographic location entitling the caller to a specified billing rate, comprising:
a mobile communications device associated with a telephone number capable of originating a call within the certain geographic location;
an antenna having at least one antenna sector capable of handling a radio communication of the call originated by the mobile phone;
a mobile switching center operatively connected to the antenna and switching the call originating from the mobile communications device, wherein the switch is capable or recording information associated with the call in a call record file including the starting time of the call, ending time of the call, telephone number associated with the mobile communications device, antenna number associated with the call, and sector number associated with the antenna; and
a billing system comprising a first database capable of receiving the call record file from the mobile switching center, a second database storing a rating profile file information comprising a second antenna number associated with the telephone number of the mobile communications device, a processor processing the call record file and rating profile file to determine an amount due associated with the call by determining whether the antenna number in the call record file matches the second antenna number indicated the rating profile file, and a third database storing the amount due associated with the call.

21. The system of claim 20 wherein the mobile switching center is operatively connected to an HLR containing the telephone number and an indication of fixed location wireless service.

22. A billing system for billing a subscriber of a wireless service comprising:
a billing processor capable of processing a call detail file received from a mobile switching center wherein the call detail record file contains records comprising the starting time of the call, ending time of the call, telephone number associated with a wireless communications device associated with the call, and a network antenna associated with the call, wherein the processing determines a bill for a subscriber in part by processing the call detail file using a rating profile to generate billing information;
a first database, operatively connected to the billing processor, storing the call detail records;
a second database, operatively connected to the billing processor, storing a subscriber rating profile comprising the telephone number associated with the wireless communications device, rating information, and antenna identification information; and
a third database operatively connected to the billing processor storing the billing information generated by the billing processor.

23. A method for handling an wireless emergency call originating from a fixed location wireless subscriber, comprising the steps of:
receiving a call origination request at a mobile switch from the fixed location wireless subscriber containing a calling party number and a dialed number;
accessing a first database and determining whether the calling party number associated with the call originating request is associated with a fixed location wireless service;
analyzing the dialed number in the call origination request and determining the dialed number is equal to 911;
accessing a second database indexed by the calling party number containing an location address associated with the fixed location wireless subscriber; and
sending the location address to a public safety answering point.
